(19) United States
(12) Patent Application Publication
(10) Pub. No.: US 2025/0262534 A1
(43) Pub. Date: Aug. 21, 2025

(54) METHODS, APPARATUSES AND COMPUTER PROGRAM PRODUCTS FOR ENHANCING PERCEIVED LARGE LANGUAGE MODEL LATENCY WITH MULTI-STAGE PROMPT

(71) Applicant: Meta Platforms Technologies, LLC, Menlo Park, CA (US)

(72) Inventor: Mokhtar Mohamed Khorshid, Kirkland, WA (US)

(21) Appl. No.: 19/058,572

(22) Filed: Feb. 20, 2025

Related U.S. Application Data
(60) Provisional application No. 63/556,331, filed on Feb. 21, 2024.

(51) Int. Cl. A63F 13/424; G06F 40/40

(52) U.S. Cl. CPC A63F 13/424; G06F 40/40

(57) ABSTRACT

Methods and systems are described to facilitate automated determination of responses to detected statements or events. The system may detect a statement(s), question, event or action. The system may further determine an intent(s), and a starter sentence(s) associated with the statement(s), question(s), event(s) or action(s). The system may further output audio or text of one or more words of the starter sentence(s). The system may further provide the intent(s) and the starter sentence(s) to at least one large language model to enable the large language model to determine a complete sentence(s) in response to the statement(s), question(s), event(s) or action(s). The system may further output audio or text of a subset(s) of the complete sentence(s) immediately after the output of the audio or the text of the one or more words of the starter sentence(s).

### CROSS-REFERENCE TO RELATED APPLICATIONS

This application claims priority to U.S. Provisional Application No. 63/556,331, filed Feb. 21, 2024, entitled “Enhancing Perceived Large Language Model Latency For Non-Player Characters With Multi-Stage Prompt,” which is incorporated by reference herein in its entirety.

### TECHNOLOGICAL FIELD

The present disclosure generally relates to systems and methods to generate artificial intelligence (AI)-based conversation.

### BACKGROUND

Every day, gamers everywhere seek an experience that is seamless and natural. As games are played, there is a desire to feel a connection with other players, even if they are non-player characters (NPCs). Historically, these non-player characters may take a while to generate a response and users may be left with a cliff-hanger. The use of artificial intelligence, large language models, or natural language understanding may greatly enhance the user experience.

### BRIEF SUMMARY

Methods and systems are described herein for the use of large language models and natural language understanding in order to decrease latency in interactions (e.g., user-NPC interactions) while using a device and/or software (e.g., head mounted displays, smartphones, tablets, gaming systems, applications (apps), smartwatches, or any other electronic device or system).

In various examples, systems or methods may receive, via a device associated with a user, a complete sentence or statement with a negligible pause or delay (e.g., 10 milliseconds (ms) or less). For example, the negligible delay may be a time period below a predetermined threshold time (e.g., 10 ms) or less). The statement that is output is calculated/determined via, or based in part on, the use of natural language understanding (NLU) and/or a large language model (LLM) following the determination of the intent associated with a statement made by a user.

The user may begin by making a statement that is then processed by the client (e.g., a software development kit (SDK), package, server, communication device, etc.). The client (e.g., a client device) may then send the statement to the natural language understanding model, which may predict the intent of the user (e.g., wisdom, advice, comedy, care, concern, etc.) and return the prediction to the client device or system in which a list of sentence starters is stored. A sentence starter may be selected and distributed first to the LLM so that the LLM may begin completing the sentence, and immediately after may provide the sentence to the user so that there is not an unnatural gap in the conversation. In the time that is taken for the sentence starter to be given to the user, the LLM may determine the remainder of the sentence that best fits the user statement and deliver the remainder of the sentence seamlessly to the client. The client may skip the words that have already been uttered to the user and return the remainder of the sentence in order to decrease lag, decrease latency, or enhance the overall user experience. By decreasing lag and/or decreasing latency, the conversation/speech of a user may be more natural, and the user experience may be enhanced as well as the technical operation of the client device may be enhanced to operate better with reduced computation power (e.g., reduced processing capacity).

In some example aspects, methods and systems are described to decrease latency in NPC gaming experiences via the use of a server or a package that may store sentence starters and which may utilize a large language model to complete the sentence starter based on the user intent. The systems and methods may include a user input that may be processed and categorized in order to generate a response using AI subsystems including, but not limited to, natural language understanding and/or large language models. These systems and methods may result in a smooth user experience via the seamless return of the synchronized response to the user device.

In one example of the present disclosure, a method is provided. The method may include detecting, by a communication device, at least one statement, question, event or action. The method may further include determining at least one intent and at least one starter sentence associated with the at least one statement, question, event or action. The method may further include outputting, by the communication device, first audio or text of one or more words of the at least one starter sentence. The method may further include providing the at least one intent and the at least one starter sentence to at least one large language model to enable the large language model to determine at least one complete sentence in response to the at least one statement, question, event or action. The method may further include outputting, by the communication device, second audio or text of at least a subset of the at least one complete sentence immediately after the outputting of the first audio or the text of the one or more words of the at least one starter sentence.

In another example of the present disclosure, an apparatus is provided. The apparatus may include one or more processors and a memory including computer program code instructions. The memory and computer program code instructions are configured to, with at least one of the processors, cause the apparatus to at least perform operations including detecting at least one statement, question, event or action. The memory and computer program code are also configured to, with the processor(s), cause the apparatus to determine at least one intent and at least one starter sentence associated with the at least one statement, question, event or action. The memory and computer program code are also configured to, with the processor(s), cause the apparatus to output first audio or text of one or more words of the at least one starter sentence. The memory and computer program code are also configured to, with the processor(s), cause the apparatus to provide the at least one intent and the at least one starter sentence to at least one large language model to enable the large language model to determine at least one complete sentence in response to the at least one statement, question, event or action. The memory and computer program code are also configured to, with the processor(s), cause the apparatus to output second audio or text of at least a subset of the at least one complete sentence immediately after the first output of the audio or the text of the one or more words of the at least one starter sentence.

In yet another example of the present disclosure, a computer program product is provided. The computer program product may include at least one non-transitory computer-readable medium including computer-executable program code instructions stored therein. The computer-executable program code instructions may include program code instructions configured to detect at least one statement, question, event or action. The computer program product may further include program code instructions configured to determine at least one intent and at least one starter sentence associated with the at least one statement, question, event or action. The computer program product may further include program code instructions configured to output first audio or text of one or more words of the at least one starter sentence. The computer program product may further include program code instructions configured to provide the at least one intent and the at least one starter sentence to at least one large language model to enable the large language model to determine at least one complete sentence in response to the at least one statement, question, event or action. The computer program product may further include program code instructions configured to output second audio or text of at least a subset of the at least one complete sentence immediately after the first output of the audio or the text of the one or more words of the at least one starter sentence.

Additional advantages will be set forth in part in the description which follows or may be learned by practice. The advantages will be realized and attainted by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates the ways in which the aspects of the invention are connected to the network in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4 illustrates the ways in which the methods and systems are connected and implemented in accordance with an example of the present disclosure.

FIG. 5 illustrates the flow of the methods and systems disclosed in accordance with an example of the present disclosure.

FIG. 6 illustrates a framework employed for evaluating captured language or responses in accordance with an example of the present disclosure.

FIG. 7 illustrates an example computer system which may be used for the systems, methods, or devices disclosed herein.

FIG. 8 illustrates an example flowchart illustrating operations to facilitate automated determination of responses to detected statements, questions, events, or actions in accordance with an example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

The following detailed description is further understood when read in conjunction with the imbedded figures. For the purpose of illustrating the disclosed subject matter, within the figures are examples of the disclosed subject matter; however, the disclosed subject matter is not limited to the specific methods, compositions, and devices disclosed. In addition, the figures are not necessarily to scale and are by no means limiting indicators of the algorithmic or application capabilities of the aforementioned systems.

Some examples of the present disclosure will now be described more fully hereinafter with reference to the accompanying drawings, in which some, but not all examples of the disclosure are shown. Indeed, various examples of the disclosure may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual/augmented reality world in which augmented reality devices may be utilized in a network (e.g., a Metaverse network) in which there may, but need not, be one or more social connections among users in the network. The Metaverse network may be associated with three-dimensional virtual worlds, online games (e.g., video games), one or more content items such as, for example, non-fungible tokens (NFTs) and in which the content items may, for example, be purchased with digital currencies (e.g., cryptocurrencies) and other suitable currencies.

As referred to herein, natural language understanding, natural language interpretation (NLI) or the like may include natural language processing in artificial intelligence and/or machine learning that may provide answers to statements and/or questions and may provide machine reading comprehension associated with events and/or actions. The NLU may be utilized/implemented to understand an intent(s) associated with an utterance(s), action(s), event(s) or the like by utilizing AI. In some instances, an NLU may be a lightweight component compared to, or in relation to, an LLM and the NLU may be executed/processed much faster (e.g., than an LLM) with fewer computational resources. An NLU may extract/determine an intent(s) and/or keyword(s)/topic(s)/entity associated with an event(s), action(s), or based on a spoken phrase. For purposes of illustration and not of limitation, for example, consider a phrase such as “I'd like to buy that sword.” In this example, the NLU may extract/determine that “buy” is the intent and the “sword” may be selected/determined as an entity.

As referred to herein, a non-player character, or non-playable character, or the like may be a character associated with, or in, a video game that may not be controlled by a player/user.

As referred to herein, a starter sentence(s), sentence starter(s), or the like may be one or more words or phrases that may begin/start a sentence to provide initial context for example a complete sentence(s) (e.g., associated with a full response to a statement(s), question(s), event(s) or action(s)).

It is to be understood that the methods and systems described herein are not limited to specific methods, specific components, or to particular implementations. It is also to be understood that the terminology used herein is for the purpose of describing particular examples only and is not intended to be limiting.

### Exemplary System Architecture

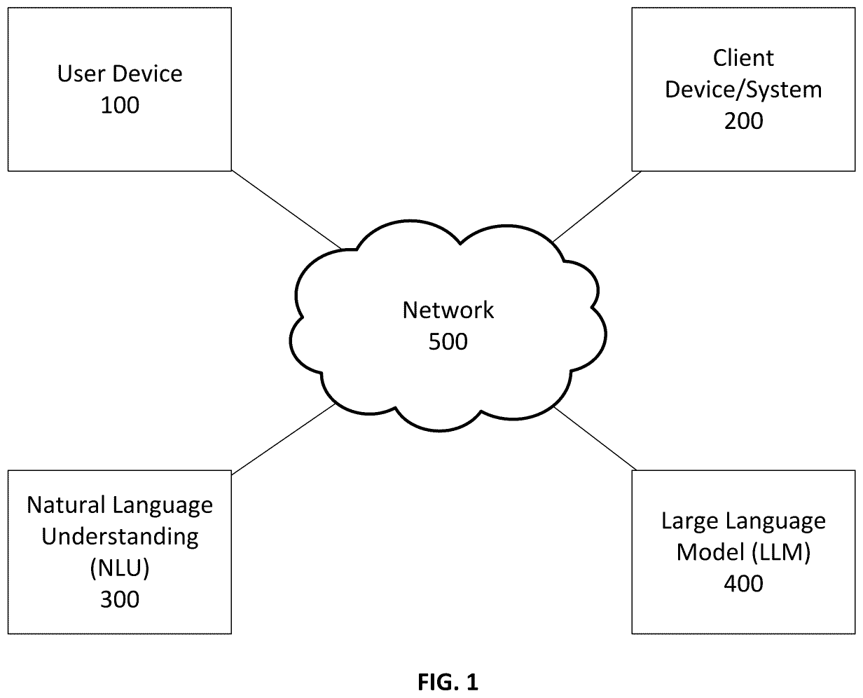

FIG. 1 is an exemplary system associated with multi-stage prompts, as disclosed herein. The system may include user device 100, client 200, natural language understanding (NLU) 300 (also referred to herein as NLU unit 300), and/or a large language model (LLM) 400 that may be connected with each other via network 500. In some examples, the client 200 may be referred to herein as client device 200 and/or system 200 (e.g., a server or network device). It is contemplated herein that the functions of FIG. 1 may be executed on one device (e.g., user device 100) or over a plurality of devices (e.g., user device 100, system 200, etc.). In some example aspects, the NLU 300 and/or the LLM 400 may be components of the user device 100 and/or system 200.

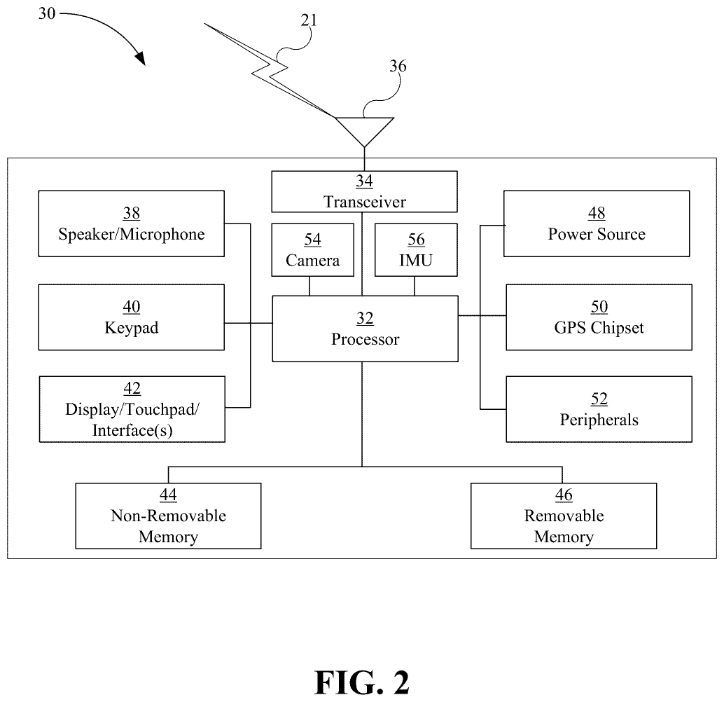

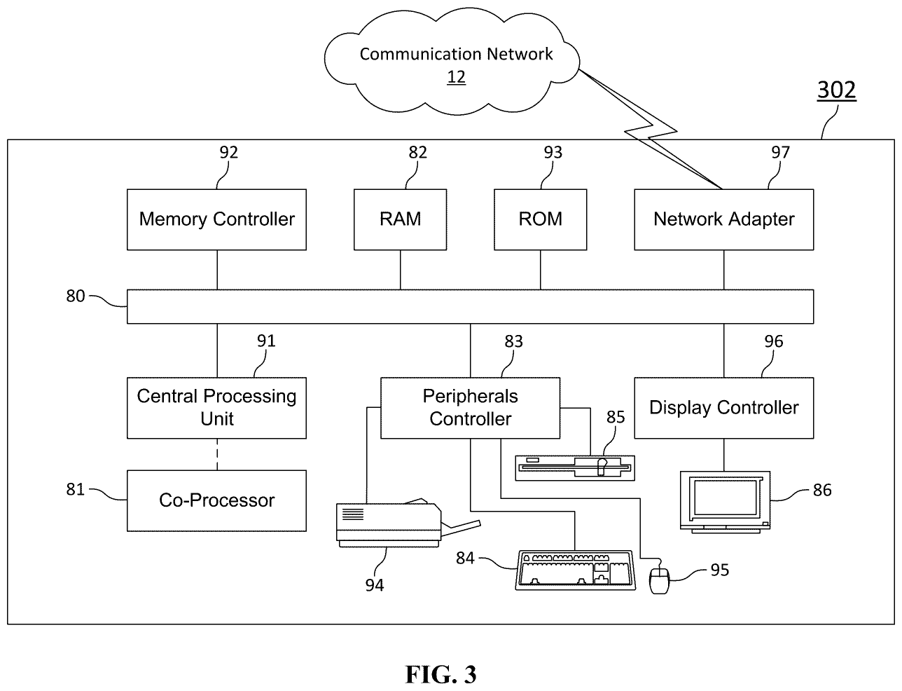

User device 100 may include an electronic device (e.g., UE 30 of FIG. 2) with input and output features which may include the ability to process sound, text, audio, or other forms of communication. User device 100 may also include a display screen and/or storage capacity. In some example aspects, the user device 100 may host client 200 and may include a head mounted display, smartphone, tablet, gaming system, apps, smartwatches, or any other electronic device or system. In other example aspects, client 200 may be a standalone device (e.g., computing system 302 of FIG. 3).

Client 200 may include a software development kit or package that may receive user input from the user device 100. Client 200 may have the ability to store sentence starters that may be sorted or categorized according to topic or intent or the ability to communicate with the NLU 300 and/or the LLM 400 in order to output the generated responses.

The NLU 300 may process the statement given/provided to the client 200, by the user device 100. The NLU 300 may process the specific statement in order to determine the intent of the input.

The LLM 400 may be able to receive a sentence starter from the client 200 and may complete the sentence that corresponds to the initial input captured or provided from the user device 100. The full response (e.g., the complete sentence) may be generated uniquely by the LLM 400 in response to each instance of a detected/received starter sentence(s). The LLM 400 may not necessarily receive a list of (available) sentence starters. The LLM 400 may receive/obtain a starter sentence(s) that has been selected/picked from the list of sentence starter(s). In this regard, the NLU 300 may select/pick a keyword/topic (e.g., an intent) based on a captured/detected sentence, statement, event, action, or the like, and may provide the selected keyword/topic (e.g., intent) to a client device. In this manner, the client device may utilize the keyword/topic (e.g., intent) to select/pick a sentence starter(s) from the list of sentence starters and may send the sentence starter(s) to the LLM 400 and to a user device (e.g., user device 100) simultaneously to enable the user device to begin outputting the sentence starter(s). The outputting by the user device (e.g., user device 100) may be output of audio and/or text of the sentence starter(s) (e.g., in a text-to-speech (TTS) fashion). In some example aspects, the list of sentence starters may be generated by another LLM (e.g., machine learning model(s) 610) and in other example aspects the list of sentence starters may be manually generated by one or more users (e.g., prior to the runtime operation (e.g., of the NLU 300 and/or LLM 400).

### Exemplary Communication Device

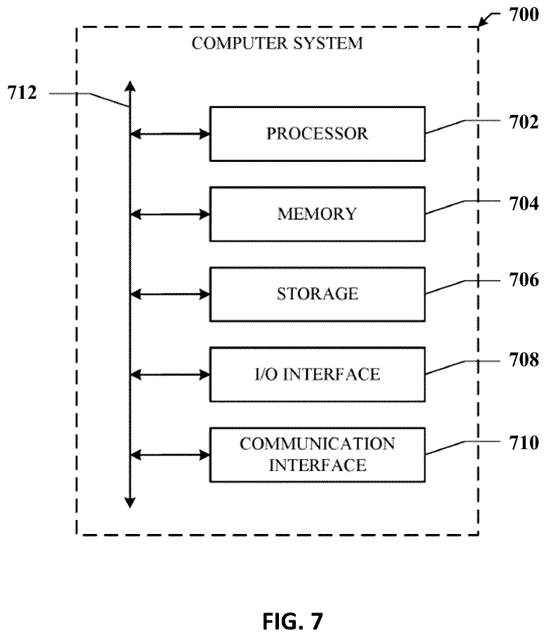

FIG. 2 illustrates a block diagram of an example hardware/software architecture of user equipment (UE) 30. In some example aspects, the UE 30 may be examples of the mobile device 111, the smartwatch 112 or a head mounted display (HMD). As shown in FIG. 7, the UE 30 (also referred to herein as node 30) may include a processor 32, non-removable memory 44, removable memory 46, a speaker/microphone 38, a keypad 40, a display, touchpad, and/or interface(s) 42, a power source 48, a global positioning system (GPS) chipset 50, an IMU 56 and other peripherals 52. The UE 30 may also include a camera 54. In an example, the camera 54 may be a smart camera configured to sense/capture images appearing within one or more bounding boxes and may capture video(s). The IMU 56 may be an electronic device that measures and reports specific force, angular rate, orientation of a device (e.g., UE 30) using a combination of accelerometers, gyroscopes, and in some instances magnetometers. The IMU 56 may also determine inertial movement of a device (e.g., UE 30). Additionally, the IMU 56 may be a sensor (e.g., a motion sensor) configured to determine changes in motion of a device (e.g., UE 30). The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

### Exemplary Computing System

FIG. 3 is a block diagram of an exemplary computing system 302. In some exemplary embodiments, the network device 160 may be a computing system 302. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 302 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 302 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 302 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 302. Such visual output may include text, graphics, animated graphics, and video. The display 86 may also include, or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 302 may contain communication circuitry, such as for example a network adaptor 97, that may be used to connect computing system 302 to an external communications network, such as network 12 of FIG. 2, to enable the computing system 302 to communicate with other nodes (e.g., UE 30) of the network.

### Exemplary System Operation

Some example aspects of the present disclosure may facilitate prompts of a NLU component for the NLU component to generate starter sentences that may be broad such as, for example, generating common starter sentences in response to statements or questions (e.g., about video game controls, weather, wisdom, advice, any suitable topic or information). The starter sentences may have a minimal text-to-speech time length that may be approximately the time it takes for an LLM to generate a full response (e.g., a complete sentence(s)) to the statement(s) or question(s).

The example aspects of the present disclosure may enable storage of the sentence starters on a communication device(s) (e.g., a database, or memory of the device). The communication device may be a client device and in some examples the starter sentence(s) may be partitioned and/or saved along with a corresponding determined intent(s). (e.g., “[Wisdom] Look my friend, my father used to tell me . . . ” in which Wisdom is the intent).

The example aspects of the present disclosure may determine the intent(s) based on a statement(s) or question(s) or an event(s)/action(s) being input or captured. For purposes of illustration and not of limitation, for example, in an instance in which a user/player of a video game is speaking to an NPC in the video game, the NLU component may perform a first pass that identifies the intent of what the user/player is talking about and may send the determined intent to the communication device.

In this regard, the communication device may pick/select at least one of the starter sentences, associated with the determined intent, at random. In the example above, for example, the communication device may then use the selected starter sentence(s) to prompt the NPC for a response to the user/player's statement or question. The NPC may be required to respond to the statement or question by the NPC outputting the words of the starter sentence(s).

The exemplary aspects may further utilize an LLM to generate a full response such as a complete sentence(s) to the statement(s), or question(s) (or event(s)/action(s)).

In this regard, the communication device may skip the common portion of the full response, as the common portion may be associated with the sentence starter(s) which has already been output or uttered (e.g., by the NPC in the example above). The communication device may enable continuing speaking of the remaining portion of the full response (e.g., the remaining text of the complete sentence(s) may be spoken by the NPC in the example above.

By implementing the above approaches, the exemplary aspects of the present disclosure may provide a smooth flowing dialogue without repetition or awkward out of place padding (e.g., filler) words. The deeper contextual words may be part of the responses to captured/input statements, questions or events/actions, thus making the responses immersive without lag and with decreased latency.

The example aspects of the present disclosure may utilize AI such as, for example, a LLM component) to quickly generate the intents and the LLM component may be utilized/implemented to determine/populate the starter sentences (e.g., for storage in a database) and to update the intents and starter sentences over time. An NLU component may understand/interpret the intents to facilitate/enable a device (e.g., client device 200) to select a sentence starter(s) associated with the interpreted intents.

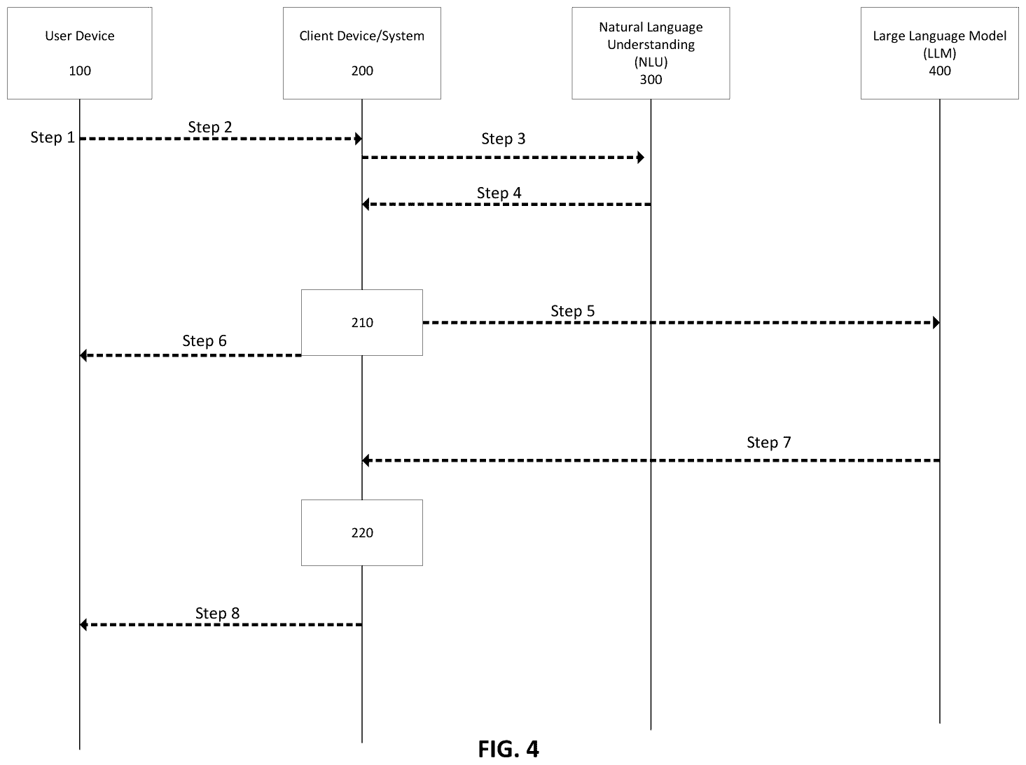

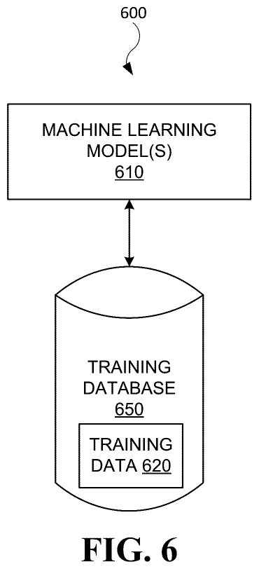

FIG. 4 is an exemplary method associated with multi-stage prompts, as disclosed herein. At step 1, user device 100 may receive a message (e.g., by a user, or an NPC, or other entity). The message may be an audio and/or a text statement or question. At step 2, the input or message of step 1 may be transmitted to client 200. At step 3, the statement or question may then be sent to NLU 300, where the intent of the statement or question is determined by the NLU 300 and sent back, by the NLU 300, to the client 200 in step 4 and the determined intent may be input into the intent database 210. At intent database 210, sentence starters may be stored and sorted into categories based on intent or subject matter. In some example aspects, the NLU may perform/determine an extraction of intent(s) based on an utterance (e.g., text or speech data from a user). In response, a device such as a client (e.g., client device 200) (or in some other implementations a server (e.g., computing system 302, computing system 700)) may utilize the intent(s) to look up the relevant list of starter sentences matching the intent. In this regard, the NLU may not necessarily populate a database (e.g., intent database 210). However, the NLU may provide the key (e.g., determined intent(s)) to utilize for looking up (e.g., indexing) the starter sentences from the list. During step 5, a sentence starter(s), associated with the statement or question, is sent to the LLM 400. While the LLM 400 is processing the sentence starter(s), associated with the statement or question, to complete the statement, the intent database 210 may return the selected sentence starter(s) to the user device 100 at step 6. Before step 6 is concluded, the LLM 400 may determine and may output the complete sentence, associated with the statement or question, to the client 200. In this manner, the syncing procedure 220 may determine what words have already been uttered to the user device 100 before syncing/synchronizing the output. The client 200 may then seamlessly output the remaining portion of the complete sentence at step 8. The output of the client 200 may be audio, text, video, and/or an image. The implementation of the example aspects of the present disclosure may result in a negligible delay and thus may minimize lag and/or latency in a communication device (user device 100, client 200) generating/providing an output to an input (or captured) statement or question by enabling the LLM 400 to determine and output to the client 200 a complete sentence in response to an input/captured statement or question, and in response to the sentence starter(s) that has been chosen (so that the response regarding the complete sentence matches the sentence starter(s)), while the intent and/or sentence starter(s) associated with the statement or question has been initially determined (e.g., by NLU 300). In this regard, a user may hear or read the full response (e.g., an output complete sentence in reply to input statement/question) without a perception of a pause or void. Steps may be executed in any order and are not limited to the aforementioned structure. In some example aspects, the NLU 300 and/or the LLM 400 may be components of the user device 100 (e.g., UE 30) and/or the client 200 (e.g., computing system 302, computing system 700). In other example aspects, the NLU 300 and the LLM 400 may be standalone components and/or embodied in other components (e.g., the NLU 300 and/or the LLM 400 may be components of the framework 600 of FIG. 6).

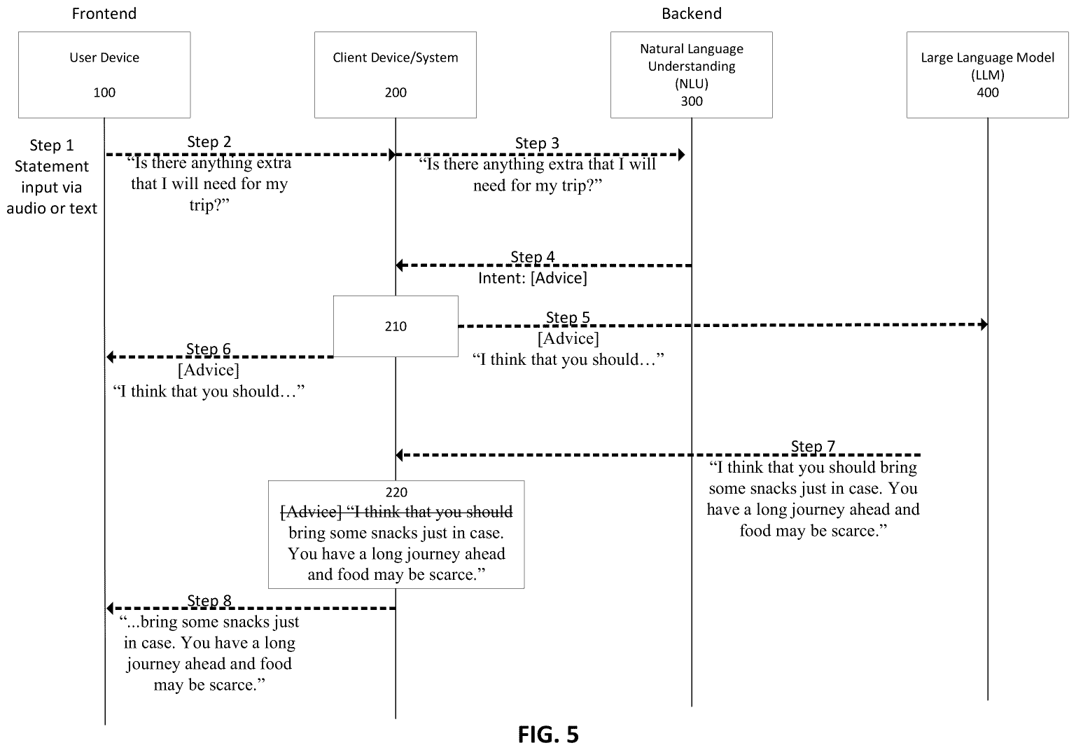

FIG. 5 is an exemplary method associated with multi-stage prompts, as disclosed in FIG. 4. Both frontend (e.g., user device 100) and backend (e.g., NLU 300) example aspects of the present disclosure are displayed. In some example aspects, the frontend may be a device such as a communication device (e.g., user device 100 (e.g., UE 30)) utilized by a user and the backend may be a backend device such as, for example, a network device (e.g., a server (e.g., computing system 302, computing system 700)). In some example aspects, the LLM 400 may also be embodied in, or implemented by, the backend (e.g., a server (e.g., computing system 302, computing system 700)). In some other example aspects, the NLU 300 and/or the LLM 400 may be embodied in a frontend, or implemented by the frontend (e.g., user device 100 (e.g., UE 30)). At step 1, user device 100 may receive a message (e.g., “Is there anything extra that I will need for my trip?”). The message may be an audio or text statement or question (e.g., by a user of the user device 100 inputting text or speaking (e.g., audio) into the user device 100). At step 2, the input or message of step 1 may be transmitted to client 200 by the user device 100. At step 3, the statement or question may then be sent to NLU 300, by the client 200, where the intent is determined (e.g., [Wisdom] or [Advice]) by the NLU 300 and the determined intent (e.g., [Advice]) may be sent back to the client 200 in step 4 and the determined intent may be input into the intent database 210. At intent database 210, sentence starters may be stored and sorted into categories based on the intent or subject matter. One sentence starter may be randomly selected (e.g., [Advice] “I think that you should . . . ”) by the NLU 300 from the intent database 210. During step 5, the selected sentence starter is sent to the LLM 400. While the LLM 400 is processing the received sentence starter to complete the statement, the intent database 210 may return the selected sentence starter to the user device 100 at step 6 (e.g., “I think that you should”). In this manner, the user device 100 may output (e.g., audio output by a speaker (e.g., speaker/microphone 38) and/or associated text output presented via a display (e.g., display/touchpad/interface(s) 42) the selected sentence starter (e.g., “I think that you should”).

Before step 6 is concluded, during step 7, the LLM 400 may output a complete sentence, in response to the statement or question initially input/captured by the user device 100, to the client 200 (e.g., “[Advice] ‘I think that you should bring some snacks just in case. You have a long journey ahead and food may be scarce.’”). The syncing procedure 220 determines what words have already been uttered/output to/by the user device 100 before syncing/synchronizing the output (e.g., of the complete sentence). For instance, in this example the syncing procedure 220 may determine that the words “I think that you should” has already been output by the user device 100. In this regard, the synching procedure 220 may show “[Advice] ‘I think that you should . . . ’” stricken in FIG. 5. The client 200 may then seamlessly output the remaining portion of the sentence at step 8 (e.g., “bring some snacks just in case. You have a long journey ahead and food may be scarce.”). The output (e.g., the remaining portion of the sentence) may be audio, text, video, and/or an image. The implementation of the example aspects of the present disclosure may result in a negligible delay. In this regard, the example aspects of the present disclosure may minimize lag and/or latency in a communication device (user device 100, client 200) generating/providing an output to an input (or captured) statement or question by enabling the LLM 400 to determine and output to the client 200 a complete sentence in response to an input/captured statement or question while an intent and/or sentence starter(s) associated with the statement or question has been initially determined (e.g., by NLU 300). The user may hear audio or read text output by user device 100 such as “I think that you should bring some snacks just in case. You have a long journey ahead and food may be scarce”, without any perceived pause or void. The steps of FIG. 5 may be executed in any order and are not limited to the aforementioned structure.

The present methods for interactions (e.g., user interactions, NPC interactions, etc.) generally utilize an LLM or NLU, however the use of these AI systems in tandem or in series may result in lower latency in generating (e.g., automated) responses to input and a more fluid interaction of the output responses. The NLU (e.g., NLU 300) pre-processing the intent of the input allows for the rapid generation of the LLM (e.g., LLM 400) response because the LLM may not have to guess the intent of the input. This pointed method allows for the optimization of the LLM and an overall enhanced user experience.

As another example consider an instance in which the a user inputs or captures a statement or question to a device (e.g., user device 100) such as for example “Is there anything that I should know when looking for a new home . . . ” In this regard, the NLU 300 may receive such input/capture and may determine that the intent/category of the statement is Wisdom. In this regard, the NLU 300 may determine one or more starter sentences (e.g., “Look my friend, my father used to tell me . . . ”) associated with the determined intent and may select the one or more starter sentences (e.g., from an intent database) for output by the device (e.g., user device 100) while the NLU 300 may also provide the determined intent and the selected one or more starter sentences to an LLM (e.g., LLM 400). In this regard, the LLM may determine a complete sentence in response to the input/captured statement or question. In this example, the LLM may determine the complete sentence as “Look my friend, my father used to tell me to consider new homes in areas of affluent schools and where other home values are high.” The LLM may need to only provide as output to the device (e.g., user device) a remaining portion of the complete sentence such as “to consider new homes in areas of affluent schools and where other home values are high” since the “Look my friend, my father used to tell me . . . ” was already provided to the device (e.g., user device 100) to be output by the device. In this manner, the example aspects of the present disclosure may automatically generate naturally sounding responses that may flow with minimal delays (e.g., minimal lag and latency), which may enhance a user experience. In this regard, the LLM may generate the remaining portion of the complete sentence. For example, the LLM may execute/operate based on a statistical model that may select/pick the most likely output (e.g., text, audio, etc.) that should follow a prompt of the sentence starter (e.g., with some randomization).

In some other example aspects of the present disclosure, the NLU may determine an intent(s) and a starter sentence(s) and the LLM may determine a complete sentence(s), associated with the starter sentence(s), in response to detection/capture of an action(s)/event(s). For purposes of illustration and not of limitation, for example, consider an instance in which a video game of a sport such as soccer is being played on the user device 100. The user device 100 may include, or otherwise be associated with, the NLU 300. In this manner, the NLU 300 may detect an action(s)/event(s) in the video game (e.g., soccer video game) such as for example a kick or header of a virtual soccer ball towards a virtual goal net in the video game. In response to detecting the attempted kick/header of the soccer ball towards the goal net, the NLU 300 may determine an intent of the action/event (e.g., to score a goal) and may output (e.g., as audio and/or text) a sentence starter(s) for audio commentary during the video game in real-time of the kick/header of the soccer ball. As an example, the sentence starter(s) determined/selected by the NLU 300 based on the action(s)/event(s) may, but need not, be audio/text such as “that was an excellent shot”.

During the video game in real-time of the kick/header of the soccer ball, the LLM 400 may also receive the selected/chosen sentence starter(s) from the NLU 300 and may continue to monitor the gameplay in response to the detection of the kick/header of the soccer ball. In this regard, the LLM 400 may determine that the follow up game play action(s) indicates that the kick/header of the soccer ball towards the goal net missed and may generate a complete sentence as, for example, “that was an excellent shot, but he kicked the ball over the goal”. Since, “that was an excellent shot” was already output by the user device 100 based on the selection/determination of the starter sentence(s) by the NLU 300, the LLM 400 may provide the remaining portion of the complete sentence “but he kicked the ball over the goal” to the user device 100 to be output (e.g., as text data and/or audio data) by the user device immediately after the user device 100 outputs the selected starter sentence(s) “that was an excellent shot.” Captured or detected events and/or actions (e.g., of a video game) may be provided in a similar manner as spoken utterances by a user. For example, the captured/detected events and/or actions may be sent as part of a prompt to an LLM (e.g., LLM 400). In this regard, in an instance in which the determined starter sentence is “that was an excellent shot”, and in which the LLM is provided a prompt (e.g., by a processor associated with the video game logic detecting a game event(s)/action(s)) pertaining to a video game player (e.g., an NPC) kicking a soccer ball an inch from a goal post, the LLM may determine a complete sentence to be output such as, for example, “That was an excellent shot, but he kicked the ball one inch off the post.” The starter sentence “that was an excellent shot” may already be output by a device (e.g., user device 100). As such, the LLM may provide the remaining portion of the complete sentence “but he kicked the ball one inch off the post” to the device to be output by the device immediately after the device outputs the selected starter sentence(s) “that was an excellent shot.”

In some example aspects, the timing of speech may not be of relevance to the LLM. On the other hand, the timing of speech may be relevant to a local device (e.g., user device 100). As described above, in response to receiving the complete sentence from the LLM, the local device may strike out the part of the complete sentence (e.g., the starter sentence(s)) that has already been output (e.g., uttered) by the local device. In this regard, the LLM may return the full response (e.g., the complete sentence) to the local device including the starter sentence(s), and the local device may perform the cutting and stitching on the output of the complete sentence (e.g., by removing the starter sentence(s), from the complete sentence, that has already been output by the local device.

The use of AI, ML, models, or NLP, among other things, may be used with one or more methods or systems associated with multi-stage prompts or the like subject matter, as disclosed herein. Artificial intelligence is the practice of developing machines that are able to behave in a capacity that far exceeds that which humans may do within a feasible amount of time. AI is situated to function without human intervention. The purpose of AI is to enable programs that are capable of data analysis and contextualization. Within an AI system there may be the following operative goals: learning, reasoning, problem solving, perception, and using language. The four subsidiary areas of functionality may be machine learning, deep learning, natural language processing, and computer vision. Data Science may be considered closely related and may depend on AI to execute its goals.

Machine Learning (ML) may be considered a subsidiary of AI. Within ML, algorithms and/or applications may be used to inform the behaviors of the system. This is done via training data (e.g., training data 620 of FIG. 6) and the recognition of patterns. There are many subsidiaries associated with ML, including but not limited to, supervised learning, unsupervised learning, semi-supervised learning, and reinforcement learning.

Training data (e.g., training data 620) is the information that is gathered and given to the system to develop a repertoire of situational actions and responses. Training is typically done all together and may include multiple pieces of data being input into the system in order to examine patterns and develop predictions (e.g., by an ML model (e.g., machine learning model(s) 610 of FIG. 6) or an AI system).

Models may reference the trained data (e.g., training data 620) when processing unseen data and make informed decisions surrounding classification and next steps to be taken. The data processing step generally may include computational methods which helps the machine “learn.”

Natural Language Processing (NLP), for example of a NLU (e.g., NLU 300), is directly connected to the roots of linguistics. The AI subsidiary has the ability to understand human language as it is written and/or spoken. When NLP is utilized, text and/or audio may be translated from one to another. NLP may also be used to process and respond to verbal commands and synthesize large amounts of text and/or audio in efforts to create/generate a summary. Some examples of this include, but are not limited to, digital assistants, GPS, dictation services and several other convenient methods for engaging a vendor.

Large language models (e.g., LLM 400) are a form of deep learning algorithm and may perform a substantial number of tasks associated with natural language processing (e.g., of an NLU (e.g., NLU 300)). LLMs are trained (e.g., on training data (e.g., training data 620)) using large databases (e.g., training database 650 of FIG. 6), which enables the model (e.g., the LLM) to complete several tasks including predicting, translating, recognizing, and/or generating text.

Data Science is utilized to synthesize and process historical information and identify patterns to make predictions. This is a symbiotic relationship as AI is trained with substantial amounts of information that may be utilized to create and devise outcomes that are beneficial to the system or person responsible for the data applications. The primary languages for data science may include, but are not limited to, programming languages such as Structured Query Language (SQL), statistical computing and data visualization languages, and other programming languages. Additionally, statistical analysis is integral to the success of the internal models used for execution. Other areas of emphasis include distributed architecture and data visualization. Both are utilized to decipher the significance of each data element. This routine generally may include two parts: predictive casual analytics and prescriptive analysis. Predictive casual analytics is most efficient when used for forecasts (e.g., business forecasts) and financial planning. The basis of this model is rooted in the processing of data to display several outcomes based upon calculation of the variables. Prescriptive analysis is optimized for the setting of a goal or desired metric. The inferences made by the predictive model may be best suited for manipulating variables to meet the desired parameters set by the system or user.

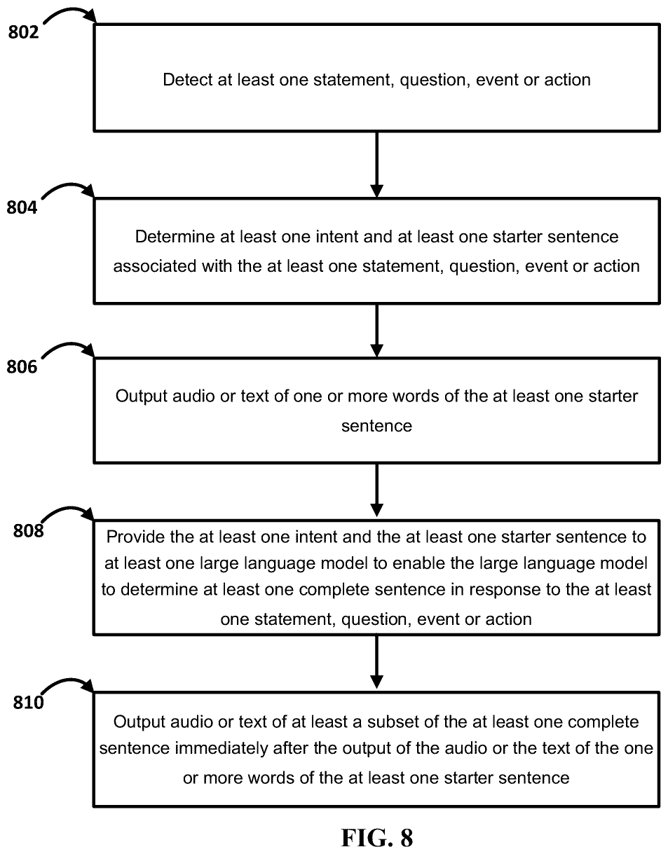

FIG. 6 illustrates a framework employed by a software application (e.g., an algorithm) for evaluating captured language or proposed responses. The framework 600 may be hosted remotely. Alternatively, the framework 600 may reside within the user device 100 shown in FIG. 1 or other devices (e.g., client 200 (e.g., computing system 302, computing system 700)) herein. Additionally, the machine learning model(s) 610 may be processed by one or more processors (e.g., controller 32 of FIG. 2, coprocessor 81 of FIG. 3, processor 702 of FIG. 7). In some examples, the machine learning model(s) 610 may be associated with operations (or performing operations) of FIG. 8. In some other examples, the machine learning model(s) 610 may be associated with other operations. The machine learning model(s) 610 is operably coupled to the stored training data 620 in a database (e.g., training database 650). In some examples, the machine learning model(s) 610 may include a natural language understanding (e.g., NLU 300) and a large language model (e.g., LLM 400).

In some example aspects, the training data 620 of the machine learning model(s) 610 (e.g., NLU 300, LLM 400) may be based on, or include, video game data, movie dialogues and/or scripts and any other suitable data. For an NLU of the machine learning model(s) 610, the training data 620 may be scoped to an experience(s) (e.g., a trip, etc.), a situation(s), a video game (e.g., intent of what a player of a video game is talking about to a NPC(s) of the video game), or the like. The training data 620 may be populated/input by users based on the users knowledge of the categories (e.g., Wisdom, Advice, Weather, Game Controls, etc.) that the NLU is intended/desired to support, or by using an LLM(s) of the machine learning model(s) 610 to provide/generate the categories. In some example aspects, the LLM(s) of the machine learning model(s) 610 may be trained on data (e.g., large amounts of data obtained from a network (e.g., network 500) such as for example the Internet). In some other example aspects, the training data 620 may include attributes of thousands of objects. For example, the object may include audio, text, images, video, combinations thereof, or the like. Attributes may include, but are not limited to the position of the text, the subject matter, etc. The training data 620 employed by the machine learning model(s) 610 may be fixed or updated periodically. Alternatively, the training data 620 may be updated in real-time based upon the evaluations performed by the machine learning model(s) 610 in a non-training mode. This is illustrated by the double-sided arrow connecting the machine learning model(s) 610 and stored training data 620. The NLU of the machine learning model(s) 610 may utilize/implement the training data 620 to determine one or more intents (e.g., categories) of a statement or question captured by or input to a device (e.g., user device 100). Based on the determined intent, the NLU may determine the intent(s) of a statement, question, event/action which may be utilized by a device (e.g., client 200) to select a sentence starter(s) associated with a list of sentence starters/phrases. In this regard, the device (e.g., client 200) may pick (e.g., randomly) from the list one or more starter sentences (e.g., the beginning portion of a sentence in response to the statement/question). The one or more starter sentences may be stored in training database 650 (e.g., an intent database 650). The LLM of the machine learning model(s) 610 may also be provided the determined intent (e.g., Wisdom, Advice, etc.) and the selected starter sentence(s) and may utilize/implement the training data 620 to determine a complete sentence in response to the statement/question while the determined intent and the selected starter sentence(s) is being provided by the device (e.g., client 200) to another device (e.g., user device 100) to be output (e.g., audio output by a speaker (e.g., speaker/microphone 38), text output by a display (e.g., display/touchpad/interface(s) 42)).

In operation, the machine learning model 610 may evaluate attributes of images/videos, dialogue, conversations, or the like obtained by hardware (e.g., user device 100, client 200, UE 30, computing system 302, computing system 700 of FIG. 7, etc.). The attributes of the captured image(s)/video(s), dialogue or the like may be compared with respective attributes of stored training data 620 (e.g., prestored objects). The likelihood of similarity between each of the obtained attributes, e.g., of the captured text and/or audio and the stored training data 620 (e.g., prestored objects) is provided a determined confidence score. In one example, in an instance in which the confidence score exceeds a predetermined threshold, the attribute is included in a description that is ultimately communicated to the user via a user interface of a computing device (e.g., user device 100, client 200 etc.). In another example, the description may include a certain number of attributes which exceed a predetermined threshold to share with the user. The sensitivity of sharing more or less attributes may be customized based upon the needs of the particular user.

FIG. 7 illustrates an example computer system 700 which may be used for the systems, methods, or devices disclosed herein. In exemplary embodiments, one or more computer systems 700 perform one or more steps of one or more methods described or illustrated herein. In particular examples, one or more computer systems 700 provide functionality described or illustrated herein. In examples, software running on one or more computer systems 700 performs one or more steps of one or more methods described or illustrated herein or provides functionality described or illustrated herein. Examples may include one or more portions of one or more computer systems 700. Herein, a reference to a computer system may encompass a computing device, and vice versa, where appropriate. Moreover, a reference to a computer system may encompass one or more computer systems, where appropriate.

This disclosure contemplates any suitable number of computer systems 700. This disclosure contemplates computer system 7800 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which can include one or more cloud components in one or more networks. Where appropriate, one or more computer systems 700 may perform without substantial spatial or temporal limitations, one or more steps of one or more methods described or illustrated herein. As an example, and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In an example, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In examples, processor 702 includes hardware for executing instructions, such as those making up a computer program. As an example, and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular examples, processor 702 may include one or more internal caches for data, instructions, or addresses. This disclosure contemplates processor 702, including any suitable number of any suitable internal caches, where appropriate. As an example and not by way of limitation, processor 702 may include one or more instruction caches, one or more data caches, and one or more translation lookaside buffers (TLBs). Instructions in the instruction caches can be copies of instructions in memory 704 or storage 706, and the instruction caches can speed up retrieval of those instructions by processor 702. Data in the data caches can be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches can speed up read or write operations by processor 702. The TLBs may speed up virtual-address translation for processor 702. In particular examples, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In examples, memory 704 includes main memory for storing instructions for processor 702 to execute or data for processor 702 to operate on. As an example, and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular examples, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In examples, one or more memory management units (MMUs) reside between processor 702 and memory 704 and facilitate accesses to memory 704 requested by processor 702. In particular examples, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In examples, storage 706 includes mass storage for data or instructions. As an example, and not by way of limitation, storage 706 may include a hard disk drive (HDD), a floppy disk drive, flash memory, an optical disc, a magneto-optical disc, magnetic tape, or a Universal Serial Bus (USB) drive, or a combination of two or more of these. Storage 706 may include removable or non-removable (or fixed) media, where appropriate. Storage 706 can be internal or external to computer system 700, where appropriate. In examples, storage 706 is non-volatile, solid-state memory. In particular examples, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 can include one or more storages 706. Although this disclosure describes and illustrates particular storage, this disclosure contemplates any suitable storage.

In examples, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers, enabling processor 702 to drive one or more of these I/O devices. I/O interface 708 may include one, or more I/O interfaces 708, where appropriate. Although this disclosure describes and illustrates a particular I/O interface, this disclosure contemplates any suitable I/O interface.

In examples, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example, and not by way of limitation, computer system 700 may communicate with an ad hoc network, a personal area network (PAN), a local area network (LAN), a wide area network (WAN), a metropolitan area network (MAN), or one or more portions of the Internet, or a combination of two or more of these. One or more portions of one or more of these networks can be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular examples, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such as, for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

FIG. 8 illustrates an example flowchart illustrating operations to facilitate automated determination of responses to detected statements, questions, events, or actions according to an example of the present disclosure. At operation 802, a device (e.g., user device 100, client device 200) may detect at least one statement, question, event or action. At operation 804, a device (e.g., user device 100, client device 200) may facilitate determining of at least one intent and at least one starter sentence associated with the at least one statement, question, event or action. In some example aspects, the determining of the at least one intent and/or the at least one starter sentence associated with the at least one statement, question, event or action may be determined by a natural language understanding component (e.g., NLU 300). In some examples, the NLU component may be a component of the device. At operation 806, a device (e.g., user device 100, client device 200) may output audio or text of one or more words/phrases of the at least one starter sentence.

At operation 808, a device (e.g., user device 100, client device 200) may provide the at least one intent and the at least one starter sentence to at least one LLM (e.g., LLM 400) to enable the LLM to determine at least one complete sentence in response to the at least one statement, question, event or action. At operation 810, a device (e.g., user device 100, client device 200) may output audio or text of at least a subset of the at least one complete sentence immediately after the output of the audio or the text of the one or more words/phrases of the at least one starter sentence. The complete sentence may include the at least one starter sentence and one or more additional words/phrases of the at least one subset. The one or more additional words/phrases may be subsequent, in the complete sentence, to the one or more words of the at least one starter sentence.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed:

1. A method comprising:
detecting, by a communication device, at least one statement, question, event or action;
determining at least one intent and at least one starter sentence associated with the at least one statement, question, event or action;
outputting, by the communication device, first audio or text of one or more words of the at least one starter sentence;
providing the at least one intent and the at least one starter sentence to at least one large language model (LLM) to enable the LLM to determine at least one complete sentence in response to the at least one statement, question, event or action; and
outputting, by the communication device, second audio or text of at least a subset of the at least one complete sentence immediately after the outputting of the first audio or the text of the one or more words of the at least one starter sentence.

2. The method of claim 1, wherein:
the at least one complete sentence comprises the at least one starter sentence and one or more additional words of the subset, wherein the one or more additional words are subsequent, in the at least one complete sentence, to the one or more words of the at least one starter sentence.

3. The method of claim 1, wherein:
the determining comprises determining by a natural language understanding (NLU) component the at least one intent and the at least one starter sentence associated with the at least one statement, question, event or action.

4. The method of claim 3, wherein:
the NLU component is embodied within the communication device or the NLU component is associated with the communication device and is remote from the communication device.

5. The method of claim 1, wherein:
the determining comprises randomly selecting the at least one starter sentence, from among a plurality of starter sentences, associated with the at least one intent.

6. The method of claim 1, further comprising:
performing the outputting of the second audio or text of the at least the subset of the at least one complete sentence in response to the LLM determining that the one or more words of the at least one starter sentence were output by the communication device.

7. The method of claim 1, wherein:
the event or the action is associated with a game event or game action occurring in real-time in a video game.

8. The method of claim 7, wherein:
the at least one starter sentence is output within, or associated with, the video game during the real-time.

9. The method of claim 7, wherein:
the at least one starter sentence and the at least one complete sentence are output as audio content or text content for a response by a non-player character (NPC) in the video game to a statement by a user of the video game whose virtual charter is interacting with the NPC.

10. The method of claim 1, wherein
performing the outputting with negligible delay, by the communication device, of the second audio or the text of the subset of the at least one complete sentence immediately after the outputting of the first audio or the text of the one or more words of the at least one starter sentence.

11. The method of claim 10, wherein:
the negligible delay comprises a time period below a predetermined threshold time.

12. An apparatus comprising:
one or more processors; and
at least one memory storing instructions, that when executed by the one or more processors, cause the apparatus to:
detect at least one statement, question, event or action;
determine at least one intent and at least one starter sentence associated with the at least one statement, question, event or action;
output first audio or text of one or more words of the at least one starter sentence;
provide the at least one intent and the at least one starter sentence to at least one large language model (LLM) to enable the LLM to determine at least one complete sentence in response to the at least one statement, question, event or action; and
output second audio or text of at least a subset of the at least one complete sentence immediately after the first output of the audio or the text of the one or more words of the at least one starter sentence.

13. The apparatus of claim 12, wherein:
the at least one complete sentence comprises the at least one starter sentence and one or more additional words of the subset, wherein the one or more additional words are subsequent, in the at least one complete sentence, to the one or more words of the at least one starter sentence.

14. The apparatus of claim 12, wherein when the one or more processors further execute the instructions, the apparatus is configured to:
perform the determine by determining by a natural language understanding (NLU) component the at least one intent and the at least one starter sentence associated with the at least one statement, question, event or action.

15. The apparatus of claim 14, wherein:
the NLU component is embodied within the apparatus or the NLU component is associated with the apparatus and is remote from the apparatus.

16. The apparatus of claim 12, wherein:
perform the determine by randomly selecting the at least one starter sentence, from among a plurality of starter sentences, associated with the at least one intent.

17. The apparatus of claim 12, wherein when the one or more processors further execute the instructions, the apparatus is configured to:
perform the output of the second audio or text of the subset of the at least one complete sentence in response to the LLM determining that the one or more words of the at least one starter sentence were output by the apparatus.

18. The apparatus of claim 12, wherein:
the at least one starter sentence and the at least one complete sentence are output as audio content or text content for a response by a non-player character (NPC) in a video game to a statement by a user of the video game whose virtual charter is interacting with the NPC.

19. A non-transitory computer-readable medium storing instructions that, when executed, cause:
detecting at least one statement, question, event or action;
determining at least one intent and at least one starter sentence associated with the at least one statement, question, event or action;
facilitating output of first audio or text of one or more words of the at least one starter sentence;
providing the at least one intent and the at least one starter sentence to at least one large language model (LLM) to enable the LLM to determine at least one complete sentence in response to the at least one statement, question, event or action; and
facilitating output of second audio or text of at least a subset of the at least one complete sentence immediately after the first output of the audio or the text of the one or more words of the at least one starter sentence.

20. The computer-readable medium of claim 19, wherein:
the at least one complete sentence comprises the at least one starter sentence and one or more additional words of the subset, wherein the one or more additional words are subsequent, in the at least one complete sentence, to the one or more words of the at least one starter sentence.
